(19) United States
(12) Patent Application Publication
(10) Pub. No.: US 2022/0254579 A1
(43) Pub. Date: Aug. 11, 2022

(54) ELECTROMAGNETIC CONTACTOR

(71) Applicant: FUJI ELECTRIC FA COMPONENTS & SYSTEMS CO., LTD., Konosu-shi (JP)

(72) Inventors: Shigenori KAWASHIMA, Kounosu-city (JP); Yukinari FURUHATA, Kounosu-city (JP); Naoki FUKAYA, Kounosu-city (JP); Kouetsu TAKAYA, Kounosu-city (JP)

(73) Assignee: FUJI ELECTRIC FA COMPONENTS & SYSTEMS CO., LTD., Konosu-shi (JP)

(21) Appl. No.: 17/731,933

(22) Filed: Apr. 28, 2022

Related U.S. Application Data
(63) Continuation of application No. PCT/JP2021/002870, filed on Jan. 27, 2021.

(30) Foreign Application Priority Data
Mar. 12, 2020 (JP) 2020-43349

(51) Int. Cl. H01H 9/02; H01H 50/14; H01H 50/02

(52) U.S. Cl. CPC H01H 9/0264; H01H 50/02; H01H 50/14

(57) ABSTRACT

An electromagnetic contactor 1 includes a case including an arc extinguishing chamber, an arc extinguishing cover attached to the case and covering the arc extinguishing chamber, and terminal covers arranged on the arc extinguishing cover and attached to the case. The case is formed with a first engagement portion, and the terminal covers are formed with a second engagement portion that is engaged with the first engagement portion to hold the terminal covers on the case. Then, the terminal covers are held on the case in either a first state where there is a gap between the first and second engagement portions or a second state where the terminal covers move in directions away from the arc extinguishing cover and the first and second engagement portions are engaged.

### CROSS-REFERENCE TO RELATED APPLICATION

This application is a continuation application filed under 35 U.S.C. § 111 (a) of International Patent Application No. PCT/JP2021/002870, filed on Jan. 27, 2021, the contents of which are incorporated herein by reference.

### TECHNICAL FIELD

The present invention relates to an electromagnetic contactor, and particularly relates to a structure for holding a terminal cover.

### BACKGROUND ART

An electromagnetic contactor includes a rear case and a front case made of a synthetic resin material having insulating properties. Terminal portions each including a contact and a coil terminal of an electromagnet are fixed to the front case, and contact portions including movable and fixed contacts are housed in an arc extinguishing chamber in the front case. The rear case houses the electromagnet and a drive lever for driving the contact portions. Additionally, an arc extinguishing cover for covering the contact portions in the arc extinguishing chamber and a terminal cover for covering the terminal portions and the coil terminal of the electromagnet are attached to the front case (for example, PTL 1).

In such an electromagnetic contactor, if an abnormally large current flows through the contact portions of the electromagnetic contactor due to a short-circuit accident or the like, an increased internal pressure of the arc extinguishing chamber caused by generation of arc gas may blow off the arc extinguishing cover.

Thus, for example, an electromagnetic contactor of PTL 2 is known in which boss shafts is formed to project outward from longitudinal one end sides of a pair of long side walls of a rectangular arc extinguishing cover, a pair of boss holes is formed in a front case, and the pair of boss shafts is fitted into the pair of boss holes to attach the arc extinguishing cover to the case.

In the electromagnetic contactor of PTL 2, when the internal pressure of the arc extinguishing chamber increases, the arc extinguishing cover rotates around the boss shafts fitted into the boss holes of the front case, and one short side of the arc extinguishing cover goes into a one-sided opening state in which the one short side rises before the other short side, as a result of which arc gas generated is externally released from a gas vent hole so that the internal pressure of the arc extinguishing chamber is reduced.

### CITATION LIST

### Patent Literature

### SUMMARY OF INVENTION

### Technical Problem

On the other hand, in the electromagnetic contactors disclosed in PTL 1 and 2, no measures have been taken to prevent the terminal cover attached to the front case from being blown off the front case when arc gas is generated.

Accordingly, it is an object of the present disclosure to provide an electromagnetic contactor that is capable of reliably preventing a terminal cover from being blown off while externally releasing arc gas generated in an arc extinguishing chamber.

### Solution to Problem

In order to achieve the above-described object, according to an aspect of the present invention, there is provided an electromagnetic contactor including: an arc extinguishing chamber including a movable contact and a fixed contact; a case including the arc extinguishing chamber; an arc extinguishing cover attached to the case and covering the arc extinguishing chamber; and a terminal cover arranged on the arc extinguishing cover and attached to the case, wherein the case is formed with a first engagement portion, and the terminal cover is formed with a second engagement portion to be engaged with the first engagement portion to hold the terminal cover on the case, the terminal cover being held on the case in either a first state where there is a gap between the first engagement portion and the second engagement portion or a second state where the terminal cover moves in a direction away from the arc extinguishing cover and the first engagement portion and the second engagement portion are engaged.

### Advantageous Effects of Invention

According to the electromagnetic contactor of the present invention, it is possible to reliably preventing a terminal cover from being blown off while externally release arc gas generated in an arc extinguishing chamber.

### BRIEF DESCRIPTION OF DRAWINGS

FIG. 1 is a perspective diagram illustrating an electromagnetic contactor of a first embodiment according to the present invention;

FIG. 2 is a diagram of the electromagnetic contactor of the first embodiment as viewed from the front side;

FIG. 3 is a perspective diagram illustrating the electromagnetic contactor of the first embodiment whose arc extinguishing cover and terminal covers have been removed;

FIG. 4 is a diagram illustrating a first engagement portion of the first embodiment formed in a part of a front case, with which the terminal cover is engaged;

FIG. 5 is a diagram illustrating a first engagement portion of the first embodiment formed in an other part of the front case, with which the terminal cover is engaged;

FIG. 6 is a cross-sectional diagram taken along line IV-IV of FIG. 2;

FIGS . 7A to 7C are diagrams illustrating a shape of the terminal covers;

FIGS. 8A and 8B are diagrams illustrating second engagement portions formed in the terminal covers, which are engaged with the first engagement portions formed in the front case;

FIG. 9 is a cross-sectional diagram illustrating the terminal cover engaged with the arc extinguishing cover;

FIG. 10 is a cross-sectional diagram illustrating the terminal cover engaged with the front case;

FIG. 11 is a diagram illustrating a state where the second engagement portion at a predetermined position formed in the terminal cover is engaged with the first engagement portion at a predetermined position formed in the front case;

FIG. 12 is a diagram illustrating a state where the second engagement portion at an other position formed in the terminal cover is engaged with the first engagement portion at an other position formed in the front case;

FIG. 13 is a diagram illustrating a state where the second engagement portion at a predetermined position formed in the terminal cover is engaged with the first engagement portion at a predetermined position of a second embodiment formed in the front case;

FIG. 14 is a diagram illustrating a state where the second engagement portion at an other position formed in the terminal cover is engaged with the first engagement portion at an other position of the second embodiment formed in the front case; and

FIG. 15 is a diagram illustrating a state of an electromagnetic contactor of the second embodiment where the terminal covers have slidingly moved in directions away from the arc extinguishing cover due to generation of arc gas.

### DESCRIPTION OF EMBODIMENTS

Next, with reference to the accompanying drawings, an embodiment according to the present invention will be described. In the following description of the drawings, the same or similar reference signs are assigned to the same or similar composing elements. However, it should be noted that the drawings are schematic and relations between thicknesses and planar dimensions, ratios among thicknesses of respective layers, and the like are different from actual ones.

Therefore, specific thicknesses and dimensions should be determined in consideration of the following description. It should also be noted that the drawings include portions having different dimensional relationships and ratios from each other.

In addition, the embodiments, which will be described below, indicate a device and a method to embody the technical idea of the present invention by way of example, and the technical idea of the present invention does not limit the materials, shapes, structures, arrangements, and the like of the constituent components to those described below. The technical idea of the present invention can be subjected to a variety of alterations within the technical scope prescribed by the claims described in CLAIMS.

Note that terms indicating directions, such as “front”, “rear”, “left”, “right”, “upper” and “lower”, that are referred to in the following description are used referring to the directions in the accompanying drawings.

### First Embodiment

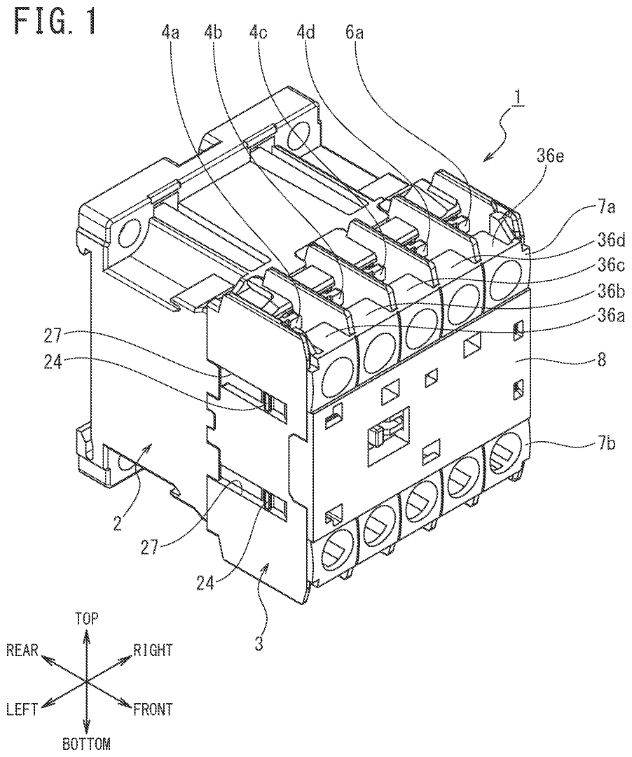

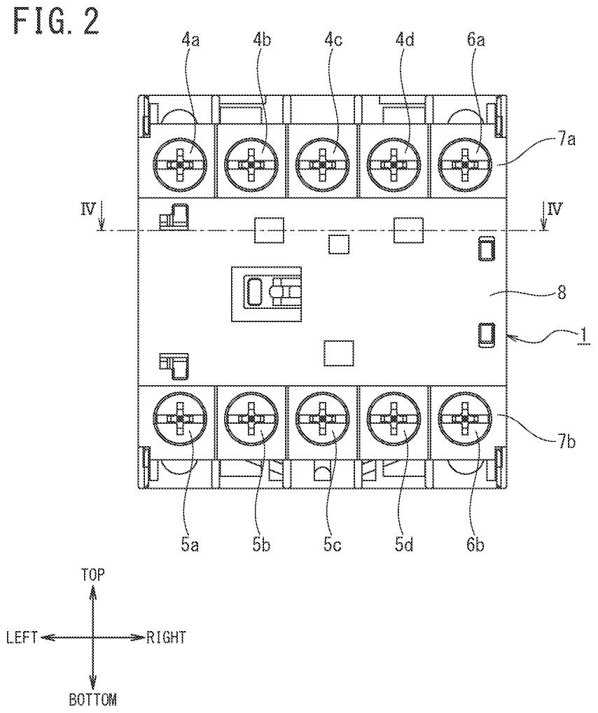

FIGS. 1 and 2 illustrate a state where an electromagnetic contactor 1 is attached to a control panel (not illustrated). The electromagnetic contactor 1 includes a rear case 2 and a front case 3 that are made of a synthetic resin material having insulating properties. Power supply-side terminal portions 4a to 4d and one coil terminal 6a of an electromagnet are arranged on an upper side of the front case 3, and load-side terminal portions 5a to 5d and an other coil terminal 6b of the electromagnet are arranged on a lower side of the front case 3. Additionally, in the front case 3, a first terminal cover 7a covering the power supply-side terminal portions 4a to 4d and the coil terminal 6a and a second terminal cover 7b covering the load-side terminal portions 5a to 5d and the coil terminal 6b are detachably engaged. Also in the front case 3, an arc extinguishing cover 8 is detachably engaged between the first terminal cover 7a and the second terminal cover 7b.

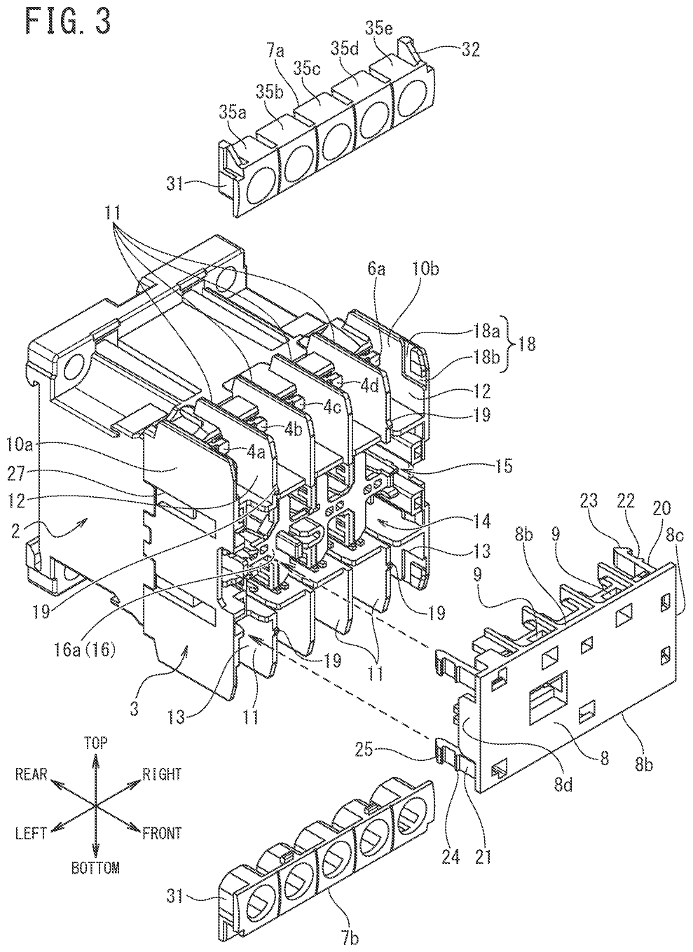

As illustrated in FIG. 3, the front case 3 includes a pair of case outer walls 10a and 10b that is separated in a left-right direction and a plurality of case inner walls 11 that is arranged in upper and lower spaces between the pair of case outer walls 10a and 10b. The case outer walls 10a and 10b and the plurality of case inner walls 11 provide five power supply-side terminal chambers 12 in the left-right direction on an upper side and five load-side terminal chambers 13 in the left-right direction on a lower side. Then, the five power supply-side terminal chambers 12 are arranged with the power supply-side terminal portions 4a to 4d and the one coil terminal 6a of the electromagnet mentioned above, and the five load-side terminal chambers 13 are arranged with the load-side terminal portions 5a to 5d and the other coil terminal 6b of the electromagnet mentioned above. Here, on front end edges of the case inner walls 11 are formed engagement protruding portions 19 that are fitted into engagement recessed portions 37 formed in the first and second terminal covers 7a and 7b that are described later.

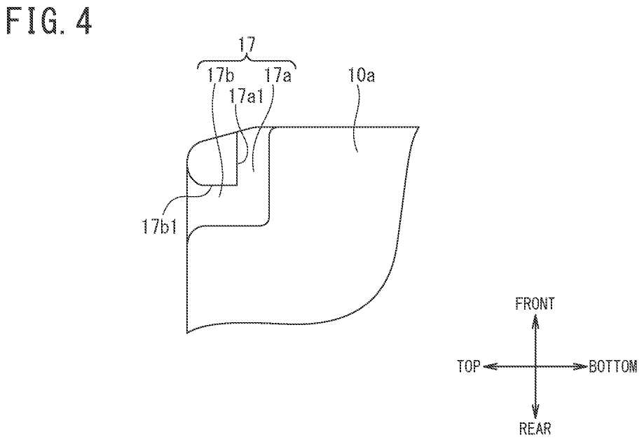

As illustrated in FIG. 4, on an inner surface of the case outer wall 10a (a surface facing the case inner wall 11) that form the front case 3, a first L-shaped grooved portion 17 is formed by a first groove line 17a extending in a front-rear direction and opening at a front end edge and a second groove line 17b being continuous behind the first groove line 17a, extending in a top-bottom direction, and opening at an upper end edge.

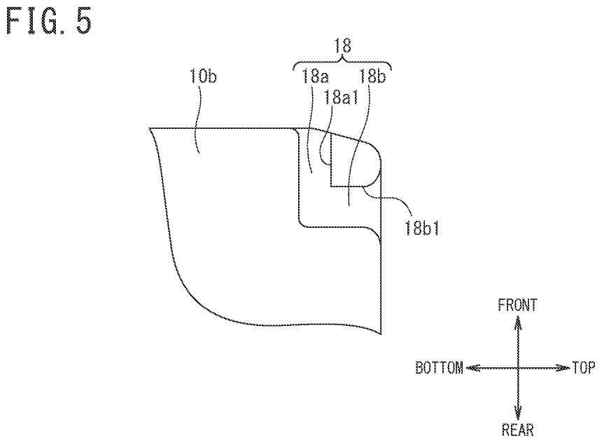

Additionally, as illustrated in FIGS. 3 and 5, also on a front inner surface of the case outer wall 10b forming the front case 3, a second L-shaped grooved portion 18 is formed by a first groove line 18a extending in the front-rear direction and a second groove line 18b being continuous behind the first groove line 18a and extending in the top-bottom direction.

Furthermore, returning to FIG. 3, an arc extinguishing chamber housing portion 15 for housing an arc extinguishing chamber 14 is provided between the power supply-side terminal chambers 12 and the load-side terminal chambers 13. A contact portion 16 is arranged in the arc extinguishing chamber 14.

The contact portion 16 includes a movable contact support 16a and a return spring (not illustrated) that is arranged at a longitudinal one end of the movable contact support 16a and that biases the movable contact support 16a to a longitudinal other end side thereof. Additionally, the longitudinal other end side of the movable contact support 16a is connected to an electromagnet (not illustrated) housed in the rear case 2 via a drive lever (not illustrated). When an excitation coil (not illustrated) forming the electromagnet is excited, the movable contact support 16a moves to the longitudinal one end side against the return spring. When the movable contact support 16a moves to the longitudinal one end side, movable contacts of a plurality of movable contact elements (not illustrated) provided on the movable contact support 16a are contacted with and separated from fixed contacts of fixed contact elements (not illustrated) provided on the power supply-side terminal portions 4a to 4d and the load-side terminal portions 5a to 5d.

The arc extinguishing cover 8 is a member made of a synthetic resin material having insulating properties, and includes a rectangular arc extinguishing cover main body 8a, a pair of long side wall portions 8b and 8b that is formed to face each other from long side edges of the arc extinguishing cover main body 8a, and a pair of short side wall portions 8c and 8d that is formed to face each other from short side edges of the cover main body 8a. The arc extinguishing cover 8 also includes a pair of engagement leg portions 20 that is formed to be spaced apart in a short side direction with one short side wall portion 8c therebetween at one short side edge of the cover main body 8a and a pair of engagement leg portions 21 that is formed to be spaced apart in the short side direction with the other short side wall portion 8d therebetween at the other short side edge of the cover main body 8a. The pair of long side wall portions 8b and 8b is formed with arc gas outlets 9 from which arc gas generated in the arc extinguishing chamber 14 is blown out. Furthermore, the pairs of engagement leg portions 20 and 21 are formed along a direction in which the arc extinguishing cover 8 is attached to the front case 3.

A first hook portion 22 projecting outward in a longitudinal direction of the cover main body 8b is formed on base end sides of the pair of engagement leg portions 20 formed at the one short side edge of the cover main body 8b, and a second hook portion 23 projecting in the same direction as that of the first hook portion 22 is formed on tip sides of the pair of engagement leg portions 20. Additionally, a first hook portion 24 projecting outward in the longitudinal direction of the cover main body 8b is formed on base end sides of the pair of engagement leg portions 21 formed at the other short side edge of the cover main body 8b, and a second hook portion 25 projecting in the same direction as that of the first hook portion 24 is formed on tip sides of the pair of engagement leg portions 21.

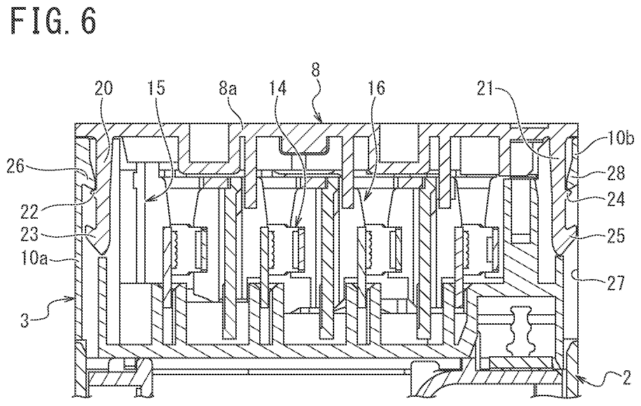

As illustrated in FIG. 6, a hook engagement portion 26 that engages with the first hook portion 22 and the second hook portion 23 of the pair of engagement leg portions 20 of the arc extinguishing cover 8 is formed on an inner wall of the case outer wall 10a of the front case 3. In addition, two slits 27 extending upward from the rear case 2 side are formed on the case outer wall 10b of the front case 3 (see FIG. 3). A hook engagement portion 28 is formed at upper end edges of the slits 27, the hook engagement portion 28 engaging with the first hook portion 24 and the second hook portion 25 of the pair of engagement leg portions 21 of the arc extinguishing cover 8.

Then, as illustrated in FIG. 6, when the arc extinguishing cover 8 is fitted into the front case 3 to cover the arc extinguishing chamber housing portion 15, the pair of long side wall portions 8b enters the arc extinguishing chamber housing portion 15, and the pairs of engagement leg portions 20 and 21 slide on the inner surfaces of the pair of case outer walls 10a and 10b of the front case 3 while elastically deforming. Then, the first hook portion 22 of each of the engagement leg portions 20 engages with the hook engagement portion 26, and the first hook portion 24 of each of the engagement leg portions 21 engages with the hook engagement portion 28. As a result, the arc extinguishing cover 8 is attached to the front case 3 while covering the arc extinguishing chamber housing portion 15.

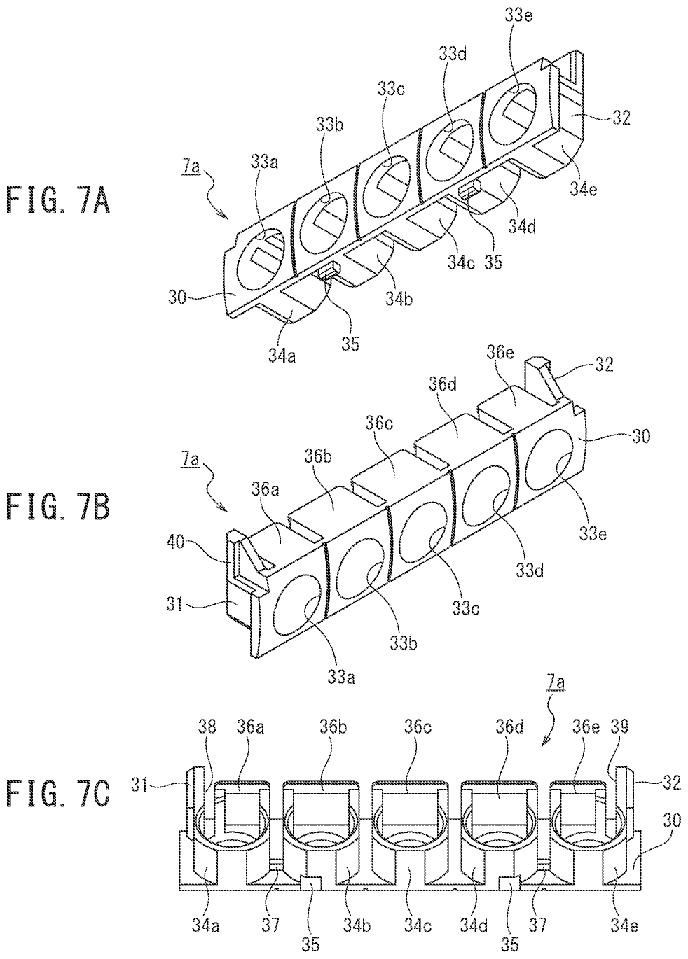

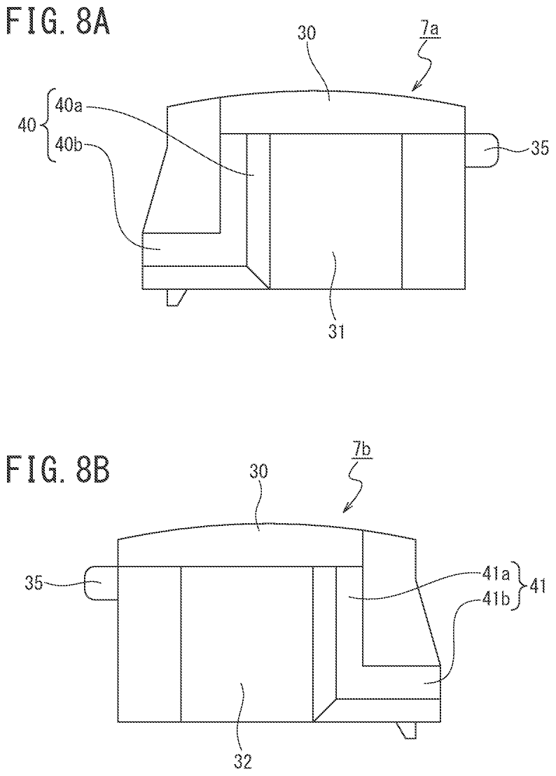

Next, a shape of the first terminal cover 7a covering the power supply-side terminal portions 4a to 4d and the coil terminal 6a is described with reference to FIGS. 7A to 7C and FIGS. 8A and 8B. Note that a shape of the second terminal cover 7b covering the load-side terminal portions 5a to 5d and the coil terminal 6b is also the same in structure as the first terminal cover 7a, and thus, only the first terminal cover 7a is described.

The first terminal cover 7a is a member made of a synthetic resin material having insulating properties, and, as illustrated in FIG. 7A, includes a cover main body 30 having a rectangular plate shape, plate-shaped cover connecting portions 31 and 32 formed at longitudinal ends of the cover main body 30, a plurality of tool insertion holes 33a to 33e communicating with a front and a back of the cover main body 30 and formed at longitudinally equal intervals, cylindrical guide portions 34a to 34e projecting from a back surface of the cover main body 30 at positions corresponding to each of the tool insertion holes 33a to 33e, and two arc extinguishing cover engagement pieces 35 formed to project outward from a widthwise one side of the cover main body 30.

Additionally, as illustrated in FIG. 7B, plate-shaped guard pieces 36a to 36e extending in the same direction as that of the guide portions 34a to 34e from a widthwise other side of the cover main body 30 are formed to be connected to the guide portions 34a to 34e, and also, as illustrated in FIG. 7C, two engagement recesses 37 are formed on the back surface of the cover main body 30.

Furthermore, as illustrated in FIG. 7C, a slit 38 is formed between the cover connecting portion 31 formed at a longitudinal one end of the cover main body 30 and the guide portion 34a and the guard piece 36a that are adjacent thereto. A slit 39 is formed also between the cover connecting portion 32 formed at a longitudinal other end of the cover main body 30 and the guide portion 34e and the guard piece 36e that are adjacent thereto.

Then, FIG. 8A illustrates the cover connecting portion 31 formed at the longitudinal one end of the cover main body 30, in which there is formed a first L-shaped protruding portion 40 including a first protruded strip 40a linearly extending toward the cover main body 30 and a second protruded strip 40b extending in a direction perpendicular to the first protruded strip 40a from an edge of the first protruded strip 40a that is farthest from the cover main body 30. In addition, FIG. 8B illustrates the cover connecting portion 32 formed at the longitudinal other end of the cover main body 30, in which there is formed a second L-shaped protruding portion 41 including a first protruded strip 41a linearly extending toward the cover main body 30 and a second protruded strip 41b extending in a direction perpendicular to the first protruded strip 41a from an edge of the first protruded strip 41a that is farthest from the cover main body 30.

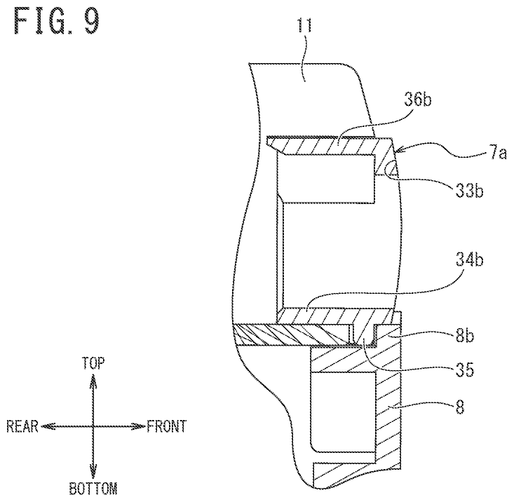

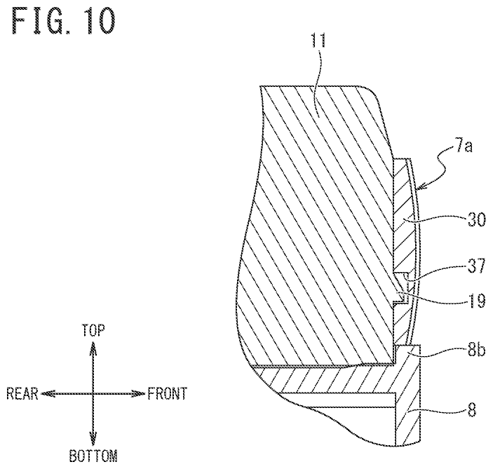

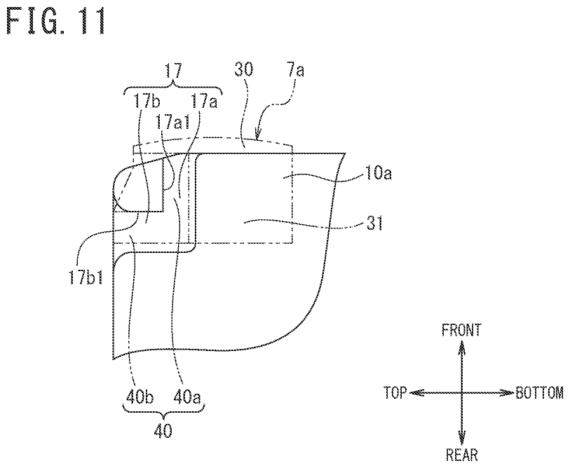

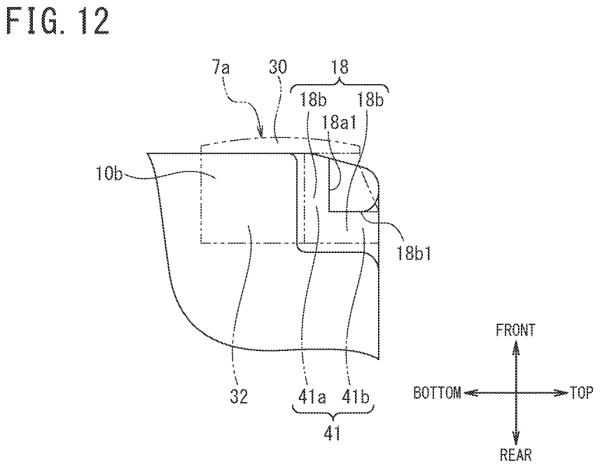

Then, as illustrated in FIG. 9, the arc extinguishing cover engagement pieces 35 of the first terminal cover 7a are inserted into a back side of the long side wall portion 8b of the arc extinguishing cover 8. By doing this, the first terminal cover 7a that was curved during molding is corrected into a straight shape. Additionally, when the first terminal cover 7a is corrected straightly, the engagement protruding portions 19 formed on the case inner walls 11 are fitted into the engagement recesses 37 formed on the back surface of the cover main body 30, as illustrated in FIG. 10. The first L-shaped protruding portion 40 of the cover connecting portion 31 engages with the first L-shaped grooved portion 17 of the case outer wall 10a (see FIG. 11) while elastically deforming the cover connecting portion 31 in a longitudinal inner side. The second L-shaped protruding portion 41 of the cover connecting portion 32 engages with the second L-shaped grooved portion 18 of the case outer wall 10b while elastically deforming the cover connecting portion 32 in a longitudinal inner side (see FIG. 12). As a result, the first terminal cover 7a is detachably attached to the front case 3.

Here, when the first L-shaped protruding portion 40 of the cover connecting portion 31 engages with the first L-shaped grooved portion 17 of the case outer wall 10a, the first protruded strip 40a of the first L-shaped protruding portion 40 abuts on a groove edge 17a1 located on an upper side of the first groove line 17a of the first L-shaped grooved portion 17, and the second protruded strip 40b of the first L-shaped protruding portion 40 abuts on a groove edge 17b1 located on a rear side of the second groove line 17b of the first L-shaped grooved portion 17, as illustrated in FIG. 11. Additionally, when the second L-shaped protruding portion 41 of the cover connecting portion 32 engages with the second L-shaped grooved portion 18 of the case outer wall 10b, the first protruded strip 41a of the second L-shaped protruding portion 41 abuts on a groove edge 18a1 located on an upper side of the first groove line 18a of the second L-shaped grooved portion 18, and the second protruded strip 41b of the second L-shaped protruding portion 41 abuts on a groove edge 18b1 located on a front side of the second groove line 18b of the second L-shaped grooved portion 18, as illustrated in FIG. 12.

Additionally, the second terminal cover 7b is also the same in structure as the first terminal cover 7a, and is detachably attached to the front case 3.

When the first and second terminal covers 7a and 7b are attached to the front case 3, the first terminal cover 7a covers the power supply-side terminal portions 4a to 4d and the coil terminal 6a, and the second terminal cover 7b covers the load-side terminal portions 5a to 5d and the coil terminal 6b, as illustrated in FIGS. 1 and 2. In addition, as illustrated in FIG. 1, the guard pieces 36a to 36e of the first terminal cover 7a extend close to the power supply-side terminal portions 4a to 4d and the coil terminal 6a, thereby making it difficult for an operator's fingers to enter the power supply-side terminals 4a to 4d and coil terminal 6a side. Furthermore, although it is not illustrated, the guard pieces 36a to 36e of the second terminal cover 7b also extend close to the load-side terminal portions 5a to 5d and the coil terminal 6b, thereby making it difficult for the operator's fingers to enter the load-side terminal portions 5a to 5d and coil terminal 6b side. Therefore, the electromagnetic contactor 1 having enhanced safety can be provided.

In the electromagnetic contactor 1 thus configured, when an abnormally large current flows through the contact portion 16 due to a short-circuit accident or the like and arc gas generated excessively increases the internal pressure of the arc extinguishing chamber 14, each engagement leg portion 20 of the arc extinguishing cover 8 elastically deforms to the right side of FIG. 6, which causes the hook engagement portion 26 to move to a top portion of the first hook portion 22 having a triangular cross section, so that the engagement state with the first hook portion 22 is disengaged. Additionally, each engagement leg portion 21 elastically deforms to the left side of FIG. 6, which causes the hook engagement portion 28 to move to a top portion of the first hook portion 24, so that the engagement state with the second hook portion 25 is disengaged. Then, the arc extinguishing cover 8 lifts up from the front case 3, whereby the second hook portion 23 of the engagement leg portion 20 meshes with the hook engagement portion 26 to maintain the engagement between the second hook portion 23 and the hook engagement portion 26, and the second hook portion 25 of the engagement leg portion 21 meshes with the hook engagement portion 28 to maintain the engagement between the second hook portion 25 and the hook engagement portion 28. As a result, a gap is formed around the entire circumference of the arc extinguishing cover main body 8a of the arc extinguishing cover 8. The gap serves as a gas vent hole to externally release the arc gas in the arc extinguishing chamber 14, so that the internal pressure of the arc extinguishing chamber 14 is reduced, thereby preventing the arc extinguishing cover 8 from being blown off.

Additionally, the first and second terminal covers 7a and 7b are located adjacent to the arc extinguishing cover 8 in the top-bottom direction thereof, and arc gas generated in the arc extinguishing chamber 14 is ejected toward the first and second terminal covers 7a and 7b from the arc gas outlets 9 formed in the pair of long side wall portions 8b and 8b of the arc extinguishing cover 8.

In the first and second terminal covers 7a and 7b, the first L-shaped protruding portion 40 formed at the cover connecting portion 31 at the longitudinal one end engages with the first L-shaped grooved portion 17 formed in the case outer wall 10a forming the front case 3 (the first protruded strip 40a abuts on the groove edge 17a1 of the first groove line 17a, and the second protruded strip 40b abuts on the groove edge 17b1 of the second groove line 17b), and the second L-shaped protruding portion 41 formed at the cover connecting portion 32 at the longitudinal other end engages with the second L-shaped grooved portion 18 formed in the case outer wall 10b forming the front case 3 (the first protruded strip 41a abuts on the groove edge 18a1 of the first groove line 18a, and the second protruded strip 41b abuts on the groove edge 18b1 of the second groove line 18b). Therefore, even when gravity or forward and vertical external forces due to the arc gas ejected toward the first and second terminal covers 7a and 7b are applied to the first and second terminal covers 7a and 7b, the first and second terminal covers 7a and 7b do not fall off the front case 3.

Accordingly, the first and second terminal covers 7a and 7b of the present embodiment are designed not to fall off the front case 3 even when forward and vertical external forces caused by arc gas ejected toward the first and second terminal covers 7a and 7b are applied thereto, since the first and second L-shaped protruding portions 40 and 41 formed at the cover connecting portions 31 and 32 at the longitudinal ends are engaged with the first and second L-shaped grooved portions 17 and 18 formed in the case outer walls 10a and 10b. This structure can reliably prevent the first and second terminal covers 7a and 7b from being blown off the front case 3.

In addition, since the cover connecting portions 31 and 32 of the first and second terminal covers 7a and 7b are the portions that are made it easy to be elastically deformed by the slits 38 and 39 formed between the adjacent guide portions 34a and 34e and guard pieces 36a and 36e. Therefore, the first and second L-shaped protruding portions 40 and 41 can be easily engaged with the first and second L-shaped grooved portions 17 and 18 of the case outer walls 10a and 10b.

Furthermore, the structure for holding the first and second terminal covers 7a and 7b on the front case 3 can be easily obtained by such a simple structure that the protruding portions (the first and second L-shaped protruding portions 40 and 41) are formed at the cover connecting portions 31 and 32 of the first and second terminal covers 7a and 7b, and the recessed portions (the first and second L-shaped grooved portions 17 and 18) are formed in the case outer walls 10a and 10b. Thus, manufacturing cost reduction can be achieved.

### Second Embodiment

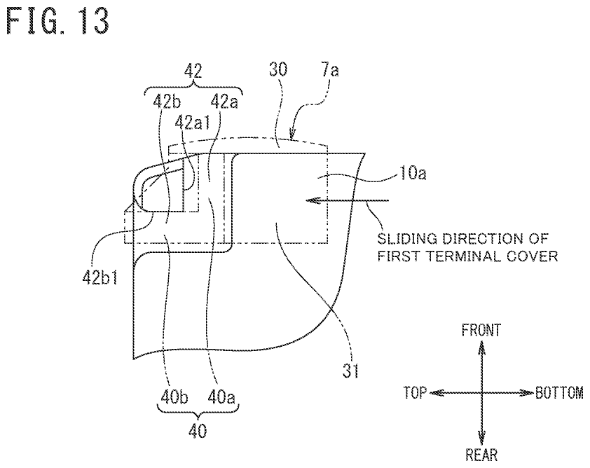

Next, FIG. 13 to FIG. 15 illustrate a main part of an electromagnetic contactor 1 of a second embodiment according to the present invention. Note that the same components as those of the electromagnetic contactor 1 of the first embodiment illustrated in FIG. 1 to FIG. 12 are denoted by the same reference signs, and description thereof is omitted. Even in the first terminal cover 7a of the second embodiment, the first L-shaped protruding portion 40 having the same structure as in the first embodiment is formed at the cover connecting portion 31, and the second L-shaped protruding portion 41 having the same structure as in the first embodiment is formed at the cover connecting portion 32. Additionally, the second terminal cover 7b is also the same in structure as the first terminal cover 7a.

As illustrated in FIG. 13, on the inner surface of the case outer wall 10a forming the front case 3, a first L-shaped grooved portion 42 of the second embodiment is formed by a first groove line 42a extending in the front-rear direction and opening at a front end edge and a second groove line 42b being continuous behind the first groove line 42a, extending in the top-bottom direction, and opening at an upper end edge.

The first groove line 42a of the first L-shaped grooved portion 42 of the second embodiment is formed larger than a groove width of the first groove line 17a of the first L-shaped grooved portion 17 of the first embodiment. When the first L-shaped protruding portion 40 of the cover connecting portion 31 is engaged, the first protruded strip 40a faces a groove edge 42a1 located on a front side of the first groove line 42a of the first L-shaped grooved portion 42 at a position away from the groove edge 42a1. Note that the second protruded strip 40b of the first L-shaped protruding portion 40 is in abutment with a groove edge 42b1 located on a front side of the second groove line 42b of the first L-shaped grooved portion 42.

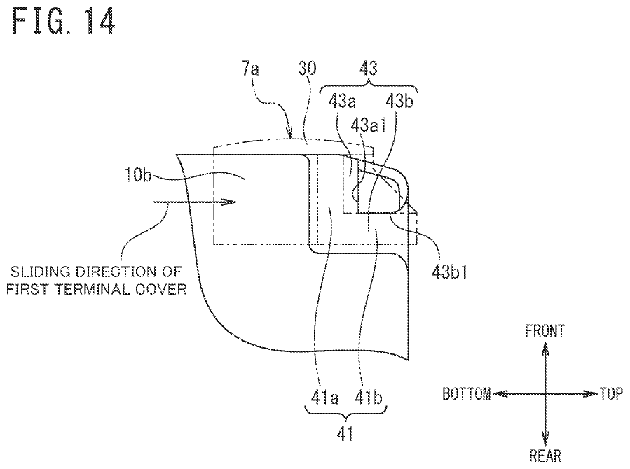

As illustrated in FIG. 14, on the inner surface of the case outer wall 10b forming the front case 3, a second L-shaped grooved portion 43 of the second embodiment is formed by a first groove line 43a extending in the front-rear direction and opening at a front end edge and a second groove line 43b being continuous behind the first groove line 43a, extending in the top-bottom direction, and opening at a lower end edge.

The first groove line 43a of the second L-shaped grooved portion 43 of the second embodiment is formed larger than a groove width of the first groove line 18a of the second L-shaped grooved portion 18 of the first embodiment. When the second L-shaped protruding portion 41 of the cover connecting portion 32 is engaged, the first protruded strip 41a faces a groove edge 43a1 located on an upper side of the first groove line 43a of the second L-shaped grooved portion 43 at a position away from the groove edge 43a1. Note that the second protruded strip 41b of the second L-shaped protruding portion 41 is in abutment with a groove edge 43b1 located on a front side of the second groove line 43b of the second L-shaped grooved portion 43.

Then, the first terminal cover 7a is attached by being engaged with the first L-shaped grooved portion 42 formed in the case outer wall 10a and the second L-shaped grooved portion 43 formed in the case outer wall 10b of the second embodiment, and the second terminal cover 7b is also attached by being engaged with the first L-shaped grooved portion 42 formed in the case outer wall 10a and the second L-shaped grooved portion 43 formed in the case outer wall 10b.

In the electromagnetic contactor 1 of the present embodiment, when arc gas generated excessively increases the internal pressure of the arc extinguishing chamber 14, the arc extinguishing cover 8 lifts up from the front case 3, as in the first embodiment, whereby a gap is formed around the entire circumference of the arc extinguishing cover main body 8a of the arc extinguishing cover 8, and the gap serves as a gas vent hole to externally release the arc gas in the arc extinguishing chamber 14, so that the internal pressure of the arc extinguishing chamber 14 is reduced, thereby preventing the arc extinguishing cover 8 from being blown off .

In addition, when the arc gas generated in the arc extinguishing chamber 14 is ejected toward the first and second terminal covers 7a and 7b from the arc gas outlets 9 formed in the pair of long side wall portions 8b and 8b of the arc extinguishing cover 8, the first terminal cover 7a is separated from one of the long side wall portion 8b of the arc extinguishing cover 8 and moves slidingly upward. In this case, in the first terminal cover 7a, the second protruded strip 40b of the first L-shaped protruding portion 40 formed at the cover connecting portion 31 slides on the groove edge 42b1 of the second groove line 42b of the first L-shaped grooved portion 42 formed in the case outer wall 10a, and the second protruded strip 41b of the second L-shaped protruding portion 41 formed at the cover connecting portion 32 slides on the groove edge 43b1 of the second groove line 43b of the first L-shaped grooved portion 43 formed in the case outer wall 10b. Then, the first terminal cover 7a stops when the first protruded strip 40a of the first L-shaped protruding portion 40 abuts on the groove edge 42a1 of the first groove line 42a of the first L-shaped grooved portion 42 and the first protruded strip 41a of the second L-shaped protruding portion 41 abuts on the groove edge 43a1 of the first groove line 43a of the second L-shaped grooved portion 43.

Additionally, the second terminal cover 7b is also separated from the other long side wall portion 8b of the arc extinguishing cover 8 and moves slidingly downward.

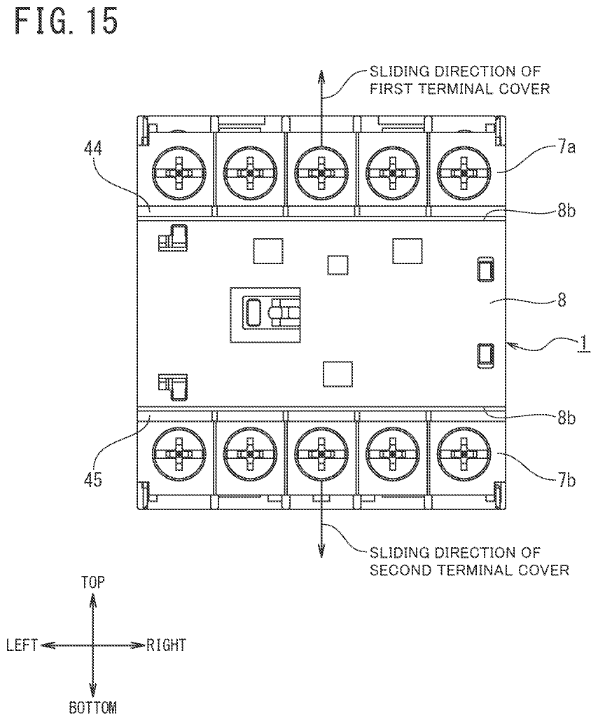

In this way, when the first terminal cover 7a moves slidingly upward and the second terminal cover 7b moves slidingly downward, gas vent spaces 44 and 45 communicating with the arc extinguishing chamber 14 are formed between each long side wall portion 8b of the arc extinguishing cover 8 and widthwise edge portions of the first and second terminal covers 7a and 7b, as illustrated in FIG. 15.

Accordingly, when the gas vent spaces 44 and 45 communicating with the arc extinguishing chamber 14 are formed by upward sliding of the first terminal cover 7a and downward sliding of the second terminal 7b due to the ejection of arc gas generated in the arc extinguishing chamber 14 toward the first and second terminal covers 7a and 7b from the pair of long side wall portions 8b and 8b side of the arc extinguishing cover 8, the amount of release of the arc gas generated in the arc extinguishing chamber 14 can be increased, which can improve breaking performance of the electromagnetic contactor 1.

It should be noted that while, in the present embodiment, the first and second L-shaped protruding portions 40 and 41 are formed at the cover connecting portions 31 and 32 of the first and second terminal covers 7a and 7b, and the first and second L-shaped grooved portions 17 and 18 (or the first and second L-shaped grooved portions 42 and 43) are formed in the case outer walls 10a and 10b, the gist of the present invention is not limited thereto. Even a structure in which engagement recessed portions (grooved portions) are formed at the cover connecting portions 31 and 32 of the first and second terminal covers 7a and 7b, and engagement protruding portions are formed on the case outer walls 10a and 10b can achieve the same advantageous effects as those of the present invention.

### REFERENCE SIGNS LIST

1: Electromagnetic contactor

2: Rear case

3: Front case

4a to 4d: Power supply-side terminal portion

6a: Coil terminal

5a to 5d: Load-side terminal portion

6b: Coil terminal

7a: First terminal cover

7b: Second terminal cover

8: Arc extinguishing cover

8a: Arc extinguishing cover main body

8b: Pair of long side wall portions

8c, 8d: Pair of short side wall portions

9: Arc gas outlet

10a, 10b: Case outer wall

11: Plurality of case inner walls

12: Power supply-side terminal chamber

13: Load-side terminal chamber

14: Arc extinguishing chamber

15: Arc extinguishing chamber housing portion

16: Contact portion

16a: Movable contact support

17: First L-shaped grooved portion (first engagement portion)

17a: First groove line

17b: Second groove line

18: Second L-shaped grooved portion (first engagement portion)

18a: First groove line

18b: Second groove line

19: Engagement protruding portion

20, 21: Engagement leg portion

22: First hook portion

23: Second hook portion

24: First hook portion

25: Second hook portion

26: Hook engagement portion

27: Slit

28: Hook engagement portion

30: Cover main body

31, 32: Cover connecting portion

33a to 33e: Tool insertion hole

34a to 34e: Guide portion

35: Arc extinguishing cover engagement piece

36a to 36e: Guard piece

37: Engagement recessed portion

38, 39: Slit

40: First L-shaped protruding portion (second engagement portion, protruding portion)

40a: First protruded strip

40b: Second protruded strip

41: Second L-shaped protruding portion (second engagement portion, protruding portion)

41a: First protruded strip

41b: Second protruded strip

42a: First groove line

42b: Second groove line

42: First L-shaped grooved portion (second engagement portion, recessed portion)

42a1: Groove edge

42b1: Groove edge

43: Second L-shaped grooved portion (second engagement portion, recessed portion)

43a: First groove line

43b: Second groove line

43a1: Groove edge

43b1: Groove edge

44, 45: Gas vent space

1. An electromagnetic contactor comprising:
an arc extinguishing chamber including a movable contact and a fixed contact;
a case including the arc extinguishing chamber;
an arc extinguishing cover attached to the case and covering the arc extinguishing chamber; and
a terminal cover arranged on the arc extinguishing cover and attached to the case, wherein
the case is formed with a first engagement portion, and
the terminal cover is formed with a second engagement portion to be engaged with the first engagement portion to hold the terminal cover on the case,
the terminal cover being held on the case in either a first state where there is a gap between the first engagement portion and the second engagement portion or a second state where the terminal cover moves in a direction away from the arc extinguishing cover and the first engagement portion and the second engagement portion are engaged.

2. The electromagnetic contactor according to claim 1, wherein the first engagement portion and the second engagement portion are slidable in the direction in which the terminal cover moves away from the arc extinguishing cover.

3. The electromagnetic contactor according to claim 1, wherein one of the first engagement portion and the second engagement portion is a protruding portion, and an other one of the first engagement portion and the second engagement portion is a recessed portion to be engaged with the protruding portion.

4. The electromagnetic contactor according to claim 3, wherein
the protruding portion is an L-shaped protruding portion formed by orthogonally aligning a first protruded strip and a second protruded strip, and
the recessed portion is an L-shaped recessed portion formed by orthogonally aligning a first groove line to be engaged with the first protruded strip and a second groove line to be engaged with the second protruded strip.

5. The electromagnetic contactor according to claim 1, wherein the terminal cover includes a cover main body having a rectangular plate shape, a plurality of insertion holes formed in communication with a front and a back of the cover main body to correspond to main circuit terminal portions, and a pair of cover connecting portions formed at longitudinal ends of the cover main body, the pair of cover connecting portions being formed with the second engagement portion.

6. An electromagnetic contactor comprising:
an arc extinguishing chamber including a movable contact and a fixed contact;
a case including the arc extinguishing chamber;
an arc extinguishing cover attached to the case and covering the arc extinguishing chamber; and
a terminal cover arranged on the arc extinguishing cover and attached to the case, wherein
the case is formed with a first engagement portion,
the terminal cover is formed with a second engagement portion to be engaged with the first engagement portion to hold the terminal cover on the case, and
the first engagement portion and the second engagement portion including a first protruded strip and a first groove line configured to prevent the terminal cover from moving in a direction away from the arc extinguishing cover and a second protruded strip and a second groove line configured to prevent the terminal cover from moving in a direction opposite to a direction in which the arc extinguishing cover is attached.

7. The electromagnetic contactor according to claim 6, wherein
the first engagement portion is an L-shaped grooved portion formed by orthogonally aligning the first groove line and the second groove line, and
the second engagement portion is an L-shaped protruding portion formed by orthogonally aligning the first protruded strip and the second protruded strip.

8. The electromagnetic contactor according to claim 2, wherein one of the first engagement portion and the second engagement portion is a protruding portion, and an other one of the first engagement portion and the second engagement portion is a recessed portion to be engaged with the protruding portion.

9. The electromagnetic contactor according to claim 8, wherein
the protruding portion is an L-shaped protruding portion formed by orthogonally aligning a first protruded strip and a second protruded strip, and
the recessed portion is an L-shaped recessed portion formed by orthogonally aligning a first groove line to be engaged with the first protruded strip and a second groove line to be engaged with the second protruded strip.

10. The electromagnetic contactor according claim 2, wherein the terminal cover includes a cover main body having a rectangular plate shape, a plurality of insertion holes formed in communication with a front and a back of the cover main body to correspond to main circuit terminal portions, and a pair of cover connecting portions formed at longitudinal ends of the cover main body, the pair of cover connecting portions being formed with the second engagement portion.

11. The electromagnetic contactor according to claim 3, wherein the terminal cover includes a cover main body having a rectangular plate shape, a plurality of insertion holes formed in communication with a front and a back of the cover main body to correspond to main circuit terminal portions, and a pair of cover connecting portions formed at longitudinal ends of the cover main body, the pair of cover connecting portions being formed with the second engagement portion.

12. The electromagnetic contactor according to claim 4, wherein the terminal cover includes a cover main body having a rectangular plate shape, a plurality of insertion holes formed in communication with a front and a back of the cover main body to correspond to main circuit terminal portions, and a pair of cover connecting portions formed at longitudinal ends of the cover main body, the pair of cover connecting portions being formed with the second engagement portion.

13. The electromagnetic contactor according to claim 8, wherein the terminal cover includes a cover main body having a rectangular plate shape, a plurality of insertion holes formed in communication with a front and a back of the cover main body to correspond to main circuit terminal portions, and a pair of cover connecting portions formed at longitudinal ends of the cover main body, the pair of cover connecting portions being formed with the second engagement portion.

14. The electromagnetic contactor according to claim 9, wherein the terminal cover includes a cover main body having a rectangular plate shape, a plurality of insertion holes formed in communication with a front and a back of the cover main body to correspond to main circuit terminal portions, and a pair of cover connecting portions formed at longitudinal ends of the cover main body, the pair of cover connecting portions being formed with the second engagement portion.
